(19) United States
(12) Patent Application Publication
(10) Pub. No.: US 2012/0078596 A1
(43) Pub. Date: Mar. 29, 2012

(54) METHOD FOR VERIFYING THE VALIDITY OF THE SIMULATION OF A SYSTEM AND CORRESPONDING DEVICE

(75) Inventors: Antoine Casta, Villefrance De Lauragais (FR); Vincent Albert, Toulouse (FR)

(73) Assignee: Airbus Operations (SAS), Toulouse (FR)

(21) Appl. No.: 12/892,638

(22) Filed: Sep. 28, 2010

(51) Int. Cl. G06G 7/48

(52) U.S. Cl. 703/6

(57) ABSTRACT

In order to verify, using a processor, the validity of a simulation of a system, a method includes providing first data representative, in a computer language, of at least one expected property of the simulation, providing second data representative, in the computer language, of the at least one property obtained by the simulation, and determining an item of information representative of the validity of the simulation on the basis of the first data and the second data.

### FIELD OF THE INVENTION

The invention relates to a method for verifying the validity of the simulation of a system and to a corresponding device.

### BACKGROUND OF THE INVENTION

It is known to simulate the operation of a system by data processing means, this generally speaking to avoid implementing experiments, for instance when it is desired to validate the operation of another system (tested system) which should in practice cooperate with the simulated system, as this is the case for on board systems in aircrafts.

It is of course sought that the simulation be as representative as possible of the behaviour of the simulated system (in particular when the goal is to qualify the tested system). Differences between the simulated behaviour and the actual behaviour necessary exist however, due to cost and time constraints in particular.

Conventionally, checking the simulation sufficiently (and thus validly) represents the actual situation is done by the responsible operators, possibly based on particular engineering methods and processes.

In this context, the invention seeks in particular to make more rational the estimation of the validity (or representativity) of a simulation and the checking of its appropriateness, in particular when a validation goal is specified.

### SUMMARY OF THE INVENTION

In this context, the invention provides a method for verifying, using a processor, the validity of a simulation of a system, comprising the following steps:
providing first data representative, in a computer language, of at least one expected property of the simulation;
providing second data representative, in the computer language, of said at least one property obtained by the simulation;
determining an item of information representative of the validity of the simulation on the basis of the first data and the second data.

Depending on the item of information obtained, verification is thus made of the validity of the simulation in a complete and accurate manner. Use of a common computer language for both the simulation objective and the simulation model used makes this rational comparison possible.

The data in the computer language (e.g. a description language) may represent various properties of physical objects of the system, such as inputs, states and outputs of one of these physical objects. In the example given below, the system is an Air Traffic System which exchange messages with ground stations.

The first data are for instance representative of at least one simulation scenario, which may comprise at least one rule defining a logical link between at least an input data of the simulation and at least an output data of the simulation.

As explained in the example given below, the data may represent the behavourial description of elements of the system, for instance as a finite state machine or automaton. The properties thus studied relate to the dynamic behaviour of the system.

Other properties may be verified thanks to the method proposed above. The first and second data may in this respect include at least one data relating to an architecture of the system, at least one data relating to representation of system elements, at least one data relating to computation implemented by the simulation and/or at least one data representing time in the simulation.

The step of determining the item of information, whereby validity of the simulation is possibly confirmed, is for instance implemented by said processor executing a query in a manipulation language, e.g. performed by a system verifying tool (such as Uppaal).

As explained below, such a query in the manipulation language may be applied simultaneously to an automaton describing the expected property of the simulation and to an automaton describing the property obtained by the simulation. In practice, this may be done by querying a composed automaton formed by the product of the two automata just mentioned.

A system verifying tool is conventionally used for verifying execution of finite state automata. It is proposed here to use this tool for comparison of the automaton describing the expected property with the automaton describing the property obtained by simulation.

The invention also provides a device for verifying the validity of a simulation of a system by data processing means, comprising:
a memory storing first data representative, in a computer language, of at least one expected property of the simulation, and second data representative, in the computer language, of at least one property obtained by the simulation;
a module (e.g. a processor) determining an item of information representative of the validity of the simulation on the basis of the first data and the second data.

The invention provides a device for verifying, using a processor, the validity of a simulation of a system, comprising:
means for providing first data representative, in a computer language, of at least one expected property of the simulation;
means for providing second data representative, in the computer language, of said at least one property obtained by the simulation;
means for determining an item of information representative of the validity of the simulation on the basis of the first data and the second data.

It is also proposed a computer readable medium storing computer program instructions, which, when executed by a computer, cause a method as described above to be performed.

### BRIEF DESCRIPTION OF THE DRAWINGS

Other features and advantages of the invention will be understood in view of the following description, made in reference to the appended drawings, where:

FIG. 1 describes a context of the example of implementation of the invention given in the following figures;

FIG. 2 describes the basic elements of a system implementing the invention;

FIG. 3 shows the various states of a first automaton used in an example of implementation of the invention;

FIG. 4 shows the various states of a second automaton used in the same example;

FIG. 5 shows the states of a third automaton used in the example described;

FIG. 6 shows the states of a first scenario to apply to these automata;

FIG. 7 represents a second scenario applied to the automata.

### DETAILED DESCRIPTION OF A PREFERRED EMBODIMENT

An example of implementation of the invention will be given in the context of the simulation of an Air Traffic System used in an aircraft for exchanging messages with ground stations.

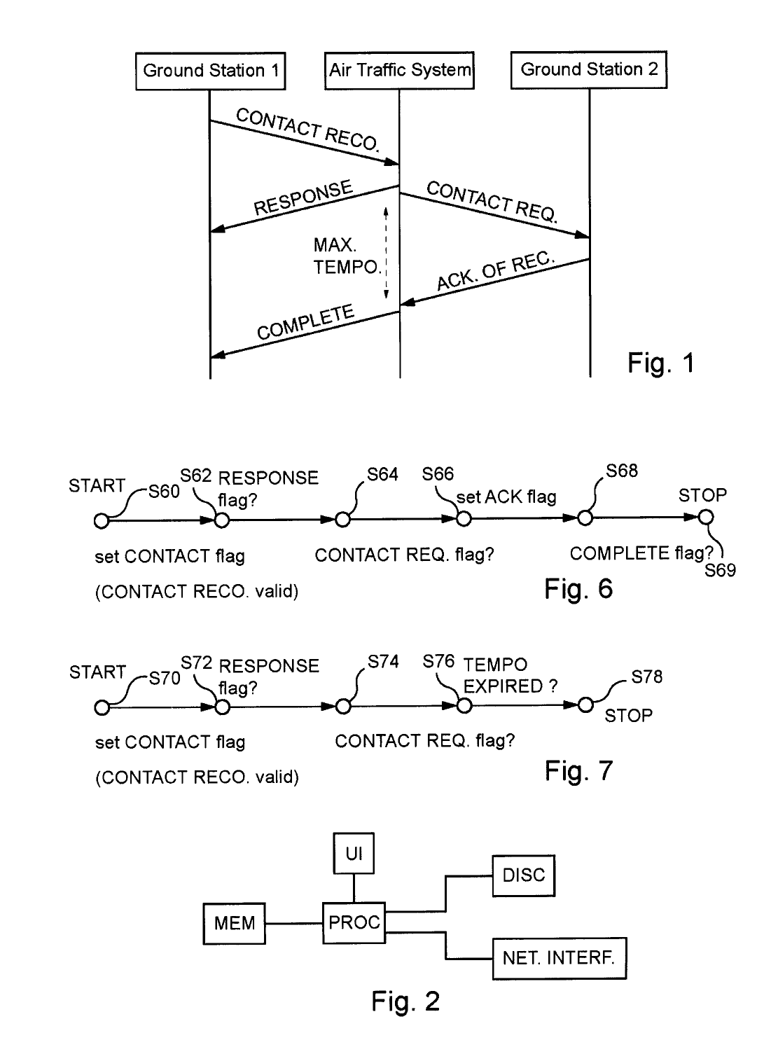

The Air Traffic System includes an application called AFN (for “Aircraft Facilities Notification”), which includes a process of “Request For Notification” as represented in FIG. 1.

This procedure should be used when the aircraft is at an increasing distance from the first ground station and should thus contact a new ground station for future communications.

As shown in FIG. 1, the procedure is initiated by the first ground station, which sends a message of contact recommendation (CONTACT RECO.).

Upon receiving this message, the Air Traffic System on board the aircraft first sends a response to the first ground station and then sends a contact request (CONTACT REQ.) to the second ground station.

The Air Traffic System of the aircraft should then receive an acknowledgement of receipt (ACK. OF REC.) within a given time frame (MAX. TEMPO.).

If the acknowledgement of receipt is received within this time frame, a message (COMPLETE) indicating the procedure is completed is sent to the first ground station.

The elements shown in FIG. 1 are simulated in a simulation system, the basic elements of which are shown in FIG. 2.

The simulation system includes a processor PROC which executes instructions forming modelisation and simulation programs.

Execution of such instructions makes it possible in particular to implement the process proposed by the invention.

The simulation system also includes a memory MEM which stores the instructions just mentioned as well as data representing models of the elements of FIG. 1 as will be further described below. The memory MEM also stores data representing scenarios to be executed for simulation of the behaviour the elements of FIG. 1 thanks to the models of these elements just mentioned.

Data representing the models and the scenarios can be loaded into the memory, for instance through the use of a disk reader DISC or through a network interface (from another system connected to the processor PROC by a network).

Simulation orders and results are respectively input to and output from the processor PROC via user interface UI (which includes in particular a screen and a keyboard).

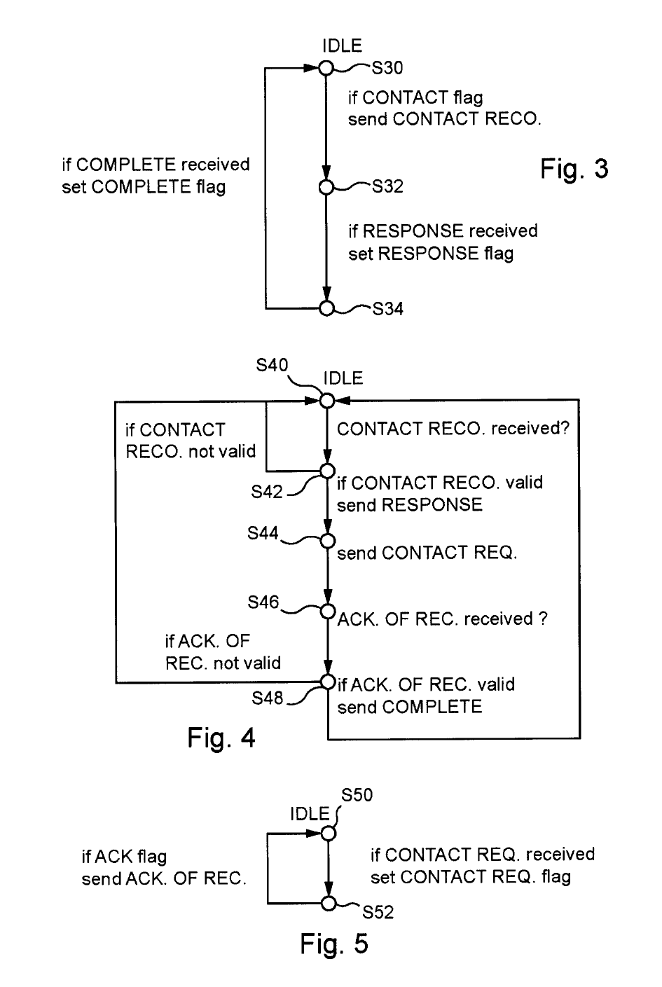

The first ground station, the Air Traffic System and the second ground station are each modelled by a finite state automaton (or finite state machine) which are now described respectively with reference to FIGS. 3, 4 and 5. In the simulation system of FIG. 2, the architecture of these models is for instance described in the SysML language (which description is stored in the memory MEM as already noted). The behaviour of each model is represented by the corresponding finite state automaton, obtained here by translating (e.g. manually) the SysML descriptions into a description of the automaton in the description language of a system verifying tool such as Uppaal. This behavioural description respresents the Simulation Domain of Use (SDU), i.e. the properties obtained by the simulation (i.e. resulting from the simulation). Data representing the description of the automaton in the description language are stored in the memory MEM.

FIG. 3 illustrates the various possible states of the automaton modelling the operation of the first ground station.

Starting from an idle state S30, the automaton transitions to state S32 if a flag referenced CONTACT is set and then sends the contact recommendation message (CONTACT RECO.) to the second automaton described below with reference to FIG. 4.

The transition from state S32 to S34 is triggered by the receipt of the response message and causes a flag referenced RESPONSE to be set.

The automaton of FIG. 3 then transitions from state S34 back to the idle state S30 if the COMPLETE message is received and would then set a flag referenced COMPLETE.

The automaton modelling the Air Traffic System is now described with reference to FIG. 4.

Starting from an idle state S40, the automaton transitions to state S42 when the contact recommendation message (CONTACT RECO.) is received.

The model used here then goes back to state S40 if the message is not a valid message. On the other hand, if the contact recommendation message is valid, the automaton sends a RESPONSE message to the ground station (represented by the model shown in FIG. 3) and steps to state S44.

The automaton then transitions to state S46 by sending a contact request message to the second ground station (here the automaton described with reference to FIG. 5 modelling the second ground station).

The automaton goes from state S46 to S48 if the acknowledgement of receipt (ACK. OF REC.) is received (by the Air Traffic System) from the second ground station, i.e. its model in the present case.

From state S48, the automaton of FIG. 4 jumps back to the idle state S40 if the acknowledgement of receipt message is not valid.

If this message is valid however, the automaton sends a COMPLETE message to the model representing the first ground station and steps back to the idle state S40.

FIG. 5 represents the states of the third automaton modelling the second ground station.

Starting from idle state S50, this automaton transitions to state S52 if a contact request message (CONTACT REQ.) is received, and then sets a flag referenced CONTACT REQ.

Then, if a flag referenced ACK is set, the third automaton modelling the second ground station sends a message of acknowledgement of receipt (ACK. OF REC.) to the second automaton modelling the Air Traffic System and transitions back to the idle state S50.

FIG. 6 represents a scenario to be executed to validate the Request For Notification process in normal conditions. This scenario is thus meant to validate the following requirements of the Air Traffic System:
upon receiving a valid contact recommendation message, the system should transmit a response message, then send the contact request message to the next ground station;
upon receiving an acknowledgement of receipt from the next ground station, the system should send a completion message to the first ground station.

The accurate sequence of the scenario is thus as follows:
sending a contact recommendation message from the first ground station (which corresponds in FIG. 6 to setting the CONTACT flag when going from state S60 to S62);
receiving a response at the first ground station (which corresponds to the transition from state S62 to S64 when the RESPONSE flag is set);
receiving a contact request message at the second ground station (which corresponds to the transition from state S64 to S66 when the CONTACT REQ. flag is set);
sending a valid acknowledgement of receipt message from the second ground station (which corresponds to setting the ACK flag when transitioning from step S66 to step S68);
receiving a COMPLETE message at the first ground station (which corresponds to stepping from state S68 to state S69 when the COMPLETE flag is set).

As clear from the above, the expected dynamic behaviour of the simulation has been converted (or translated) from logical assertions into a computer representation (here a finite state machine described in Uppaal description language by corresponding data stored in the memory MEM). This representation is a description of the Simulation Objective of Use (SOU) and thus describes expected properties of the simulation, here expected properties of the dynamic behaviour of the simulation.

Interestingly, the description of the Simulation Domain of Use (SDU) and the description of the Simulation Objective of Use (SOU) are made in the same computer language (here the description or modelling language of the Uppaal tool).

In order to check the validity of the models described above with reference to FIGS. 3 to 5 with respect to the simulation requirements (or constraints) defined in the scenario just mentioned, the finite state machines representing both the scenario and the models are executed by applying the stimuli of the automaton (or finite state machine) describing the scenario on the automata describing the ground station and Air Traffic System models.

The dynamic behaviour of the models will be satisfying for the requirements defined by the scenario if the stimuli of the scenario applied to the model automata makes it possible to run through all the steps of the scenario, i.e. to transition from the start state of the scenario automaton to the stop state of the scenario automaton. This is because reaching the stop state of the scenario implies that all the objectives (or expected properties) listed in the scenario have been successfully processed through.

The validity of this condition is determined by the processor PROC (e.g. as proposed below) and the processor correspondingly updates an item of information (e.g. in the memory MEM) representative of the validity of the simulation by the models. This item of information is for instance displayed as an indicator on the screen of the user interface UI.

In practice, this is done for example by advancing through the automata thanks to the use of the Uppaal manipulation language (or query language) allowing the processor PROC to verify whether constraints or requirements are verified. Precisely, a single automaton (composed automaton) formed by the logical product of the automaton defining the simulation requirements and the automaton (here formed of three automata) representing the models is executed. In a composed automaton, stimuli are applied at the same time to the various automata forming the composed automaton.

For verification of the validity of the simulation with respect to the requirements defined in the scenario, use can be made for instance of the verification mode of Uppaal (executed by the processor PROC) which gives information on this single automata, and in particular on the fact that there exists at least one possible sequence or path making it possible to go from the start state to the stop state (path formula “E< > scenario.STOP”), i.e. as explained above, that the models meet the simulation requirements defined in the scenario.

In the case of the scenario shown in FIG. 6, processing the various steps and following the actions triggered in the models of FIGS. 3 to 5 allows to successively step through the various states and reach the stop state. The response to the query mentioned above (as to whether there exists a sequence reaching the stop state, formulated “E< > scenario.STOP”) will thus be a positive indicator (green light displayed in the verification mode screen in the Uppaal tool).

As a consequence, the three models described in FIGS. 3 to 5 are a sufficient modelling of the ground station and Air Traffic System for fulfilling the constraints of the scenario. The simulation is considered valid with respect to these constraints.

FIG. 7 represents another scenario defining the requirements of a simulation, in the present case with respect to the expiration of the timer (MAX. TEMPO.) triggered when sending the contact request.

Steps for transitioning from states S70 to S76 are identical to those described with reference to FIG. 6 for transitioning to step S60 to S66 and are therefore not described again.

The scenario of FIG. 7 is designed to go from state S76 to state S78 if a flag corresponding to the expiration of the temporisation (or timer) is set.

When applying the stimuli provided by this scenario to the automata described above with reference to FIGS. 3 to 5 (for instance using the Uppaal tool as explained above), the various automata will step from states to states, up to the state corresponding to state S76 in the scenario automaton.

However, as expiration of the timer is not provided in the models described above, the corresponding flag is never set and the automata (in particular the scenario automaton of FIG. 7) never reaches the stop state S78.

For example, the verification screen in Uppaal displays that no path exists for going from the start state S70 to the stop state S78 (red light indicator in response to the query mentioned above: “E< > scenario.STOP”).

This means that the simulation models provided by the automata of FIGS. 3 to 5 does not sufficiently (i.e. validly) represent the dynamic behaviour of the Air Traffic System with respect to the constraints defined in the scenario of FIG. 7.

The above embodiments are only a possible implementation of the invention, which is not limited thereto.

1. A method for verifying, using a processor, the validity of a simulation of a system, comprising the following steps:
providing first data representative, in a computer language, of at least one expected property of the simulation;
providing second data representative, in the computer language, of said at least one property obtained by the simulation;
determining an item of information representative of the validity of the simulation on the basis of the first data and the second data.

2. The method of claim 1, wherein the first data are representative of at least one simulation scenario.

3. The method of claim 2, wherein the simulation scenario comprises at least one rule defining a logical link between at least an input data of the simulation and at least an output data of the simulation.

4. The method according to any of claims 1 to 3, wherein the first and second data include at least one data relating to an architecture of the system.

5. The method according to any of claims 1 to 3, wherein the first and second data include at least one data relating to representation of system elements.

6. The method according to any of claims 1 to 3, wherein the first and second data include at least one data relating to computation implemented by the simulation.

7. The method according to any of claims 1 to 3, wherein the first and second data include at least one data representing time in the simulation.

8. The method according to any of claims 1 to 3, wherein said step of determining the item of information is implemented by said processor executing a query in a manipulation language.

9. The method according to claim 8, wherein said query is performed by a system verifying tool.

10. A device for verifying the validity of a simulation of a system by data processing means, comprising:
a memory storing first data representative, in a computer language, of at least one expected property of the simulation, and second data representative, in the computer language, of at least one property obtained by the simulation;
a module determining an item of information representative of the validity of the simulation on the basis of the first data and the second data.

11. A device for verifying, using a processor, the validity of a simulation of a system, comprising:
means for providing first data representative, in a computer language, of at least one expected property of the simulation;
means for providing second data representative, in the computer language, of said at least one property obtained by the simulation;
means for determining an item of information representative of the validity of the simulation on the basis of the first data and the second data.
